(19) United States
(12) Patent Application Publication
(10) Pub. No.: US 2011/0188790 A1
(43) Pub. Date: Aug. 4, 2011

(54) Hydraulically Damping Bushing Bearing

(75) Inventors: Josef Eschweiler, Wartberg (DE); Josef Peter Gross, Sinzig-Westum (DE)

(73) Assignee: ZF FRIEDRICHSHAFEN AG, Friedrichshafen (DE)

(21) Appl. No.: 13/002,890

(22) PCT Filed: Jul. 15, 2009
(86) PCT No.: PCT/DE2009/050038

§ 371 Date: Mar. 23, 2011

(30) Foreign Application Priority Data
Jul. 18, 2008 (DE) 10 2008 040 548.5

(51) Int. Cl. F16C 27/00

(52) U.S. Cl. 384/99

(57) ABSTRACT

Chambers for a bushing bearing with damping means include outer sleeve and inner bearing part, accommodated in the outer sleeve with rigid bearing core and elastomeric bearing body surrounding the core. The expanding walls of the chambers are disposed transversely to the bearing axis (A). The inner bearing part is segmented with respect to the longitudinal axis (A) of the bearing and includes a center main segment with bearing core and bearing body and two end segments, each having an inner ring, an outer ring, and an interposed elastomeric element forming expanding wall of a chamber. The end segments are pressed with inner ring onto axial ends of the bearing core so that the material overlaps between the elastomeric elements of the end segments and the ribs of the bearing body. The channel is formed outside of the bearing body in a channel carrier element.

This is an application filed under 35 USC §371 of PCT/DE2009/050038, claiming priority to DE 10 2008 040 548.5 filed on Jul. 18, 2008.

### BACKGROUND OF THE INVENTION

(1) Field of the Invention

The invention relates to an elastomeric bushing bearing with hydraulic damping. The invention more particularly relates to a bushing bearing with a special configuration which makes it possible to realize a bushing bearing which is thermally very robust.

(2) Description of Related Art

Elastomeric bushing bearings of a type employed in large numbers particularly in the construction of vehicles consist essentially of a metallic, mostly rotationally symmetric and frequently cylindrical bearing core, an outer sleeve which surrounds the bearing core and is generally also made of metal, and an elastomeric bearing body arranged between the bearing core and the outer sleeve and forming an elastomeric support spring. The elastomeric bearing body is generally connected by vulcanization at least with the bearing core, optionally also with the outer sleeve. Depending on the application, the damping effect of the bushing bearings is aided by a radially operating hydraulic damping system which is integrated in the bearing. To this end, at least two chambers adapted to receive fluidic damping means are formed in the bushing bearing or its bearing body and are connected for fluid conduction by a damping means channel. If a load is applied to the bearing with a force acting on one of the chambers in a radial direction, then the fluidic damping means residing in this chamber is displaced through the damping means channel into the respective other chamber.

Depending on the design of the aforementioned channel and the channel geometry, respectively, the damping characteristic of the bearing is aided by mass or flow restrictor damping produced by the hydraulic damping system. The channel connecting the chambers with each other is formed either directly in the elastomeric bearing body or in a separate channel support element arranged inside the bearing body or surrounding the bearing body. A generic bearing is described, for example, in DE 40 20 713 C2.

In general, the bearings also include a stop element formed or arranged on the bearing for limiting the spring excursion of its support body defined by the chambers. In particular with bearings having a radially operating hydraulic damping system, the chambers extending in the bearing and the damping means channel frequently limiting the space available for forming corresponding stop elements or stop faces and may hence cause problems. In many instances, the stop elements are therefore realized as a part of additional clips, preferably made of plastic, which are pressed onto the axial end faces of the bushing bearing.

The bushing bearings can be connected with the other components at the installation site by pressing the bushing bearings into a receiving eye formed on one of these components and additionally attaching them to the inner part with a screw connection. If the stop elements are realized by the clips pressed onto the axial ends, then the corresponding receiving eye must be constructed so as to surround the bearing along its entire axial length. For example, a connecting rod for a motor vehicle receiving the bearing in a receiving eye must then be relatively wide. In addition, the comparatively small stop elements or stop faces in the clips may create problems by limiting loading by cardanic operating forces acting on radially damping bushing bearings. Accordingly, it would be desirable to construct the bearing geometry so as to have the largest possible stop faces.

A similar result is obtained, for example, with a bearing constructed according to EP 01 99 240 A2. The damping means chambers are formed in the bearing described in this document at the axial bearing ends, thereby leaving adequate space in the bearing center for forming stop elements. For realizing the chambers, caps are placed on the axial ends of a main bearing part, with the caps consisting of an outer and an inner ring made of a rigid material and an interposed elastomeric ring. The chambers, which are mutually offset in the circumferential direction of the bearing, are connected with each other by a damping means channel extending between the elastomer of the caps and the elastomer of the bearing body of the main bearing part. By eliminating a channel support element and constructing the channel walls from the elastomer of the bearing body and the caps, respectively, the geometry of the damping means channel is disadvantageously not clearly defined. Instead, the geometry changes depending on the applied load and the resulting deformation of the elastomer surrounding the channel. This is disadvantageous in particular with cardanic loads of the bearing, because the bearing's damping characteristic for large cardanic loads cannot be reliably predicted due to the accompanying changes in the channel geometry.

It has also been observed that conventional elastomeric bushing bearings can only withstand a limited thermal load. When used in automobiles, increased wear occurs on the bearings in regions with a very hot climate. Due to the high temperatures, the elastomer of the bearing body frequently becomes brittle. If these bearings are used for hydraulic damping, leaks may occur in the region of the bearings, causing the bearing to fail under adverse conditions where it does not provide the intended damping effect.

### BRIEF SUMMARY OF THE INVENTION

It is therefore an object of the invention to provide an elastomeric bushing bearing with hydraulic damping which eliminates the aforementioned problems.

In particular, the provided bushing bearings should also be constructed for high cardanic loads and have large-area stop elements. In addition, even with large mechanical and/or thermal loads applied to the bearing, the hydraulic damping system should remain leak-tight and the realization of particularly temperature-robust bearings should preferably also be possible based on the concept of this solution.

The object is attained with an elastomeric bushing bearing having the features of the independent claim. Advantageous embodiments or modifications of the invention are recited in the dependent claims.

The hydraulically damping bushing bearing proposed for attaining the object includes, as generally known, an outer sleeve and an inner bearing part received by the outer sleeve with a rigid, sleeve-shaped or strand-shaped metallic bearing core, an elastomeric bearing body surrounding the bearing core and connected to the bearing core by vulcanization, and at least two chambers for receiving fluidic damping means. The aforementioned chambers each have at least one elastomeric expanding wall, which are offset with respect to each other in the circumferential direction of the bearing and separated from each other by ribs of the bearing body; however, the chambers are connected with each other by at least one channel through which damping means can flow from one chamber into the other. Depending on the intended application of the bearing, the channel connecting the chambers is formed by a suitable geometry, concerning in particular the channel length, either as a mass damping channel or as a flow restrictor channel. Preferably, radial stops formed by the elastomer of the bearing body are disposed in the chambers.

Moreover, in the bearing proposed for attaining the object, the inner bearing part is segmented along the longitudinal axis of the bearing. The aforementioned expanding walls of the chambers are positioned horizontally, i.e., transverse to the bearing axis. To this end, they are constructed as a part of two end segments, which are each arranged on a corresponding end face of a center main segment of the inner bearing part and held by the bearing core and the outer sleeve on the center main segment of the inner bearing part. The end segments each consist of a rigid inner ring, a rigid outer ring and an elastomeric element arranged between the inner ring and the outer ring. According to the invention, the end segments are pressed with their inner ring with a press fit onto the axial ends of the bearing core arranged in the center main segment such that the material overlaps between the elastomeric element of the end segments and the ribs of the bearing body in the radial direction of the bushing bearing. The ribs of the bearing body and the elastomeric elements of the end segments are hereby pretensioned relative to each other or are under a pretension. According to the invention, the chambers are sealed in the region of the ribs against the bearing body and hence also with respect to each other by the overlapping material. Due to the seal of the chambers against the ribs of the bearing body, the channel connecting the chambers with each other is displaced outwardly. The channel is formed in a rigid channel support element arranged between the bearing body and the outer sleeve and is connected with the bearing body through vulcanization. According to a preferred embodiment of the invention, the aforementioned channel support element is made of plastic. The end segments are held on the center segment, on one hand, by the press fit between the inner rings and the bearing core and, on the other hand, by a constriction on the end face of the outer bearing sleeve, i.e., the position of the end segments with respect to the main segment is fixed in the axial direction.

In a particularly preferred embodiment of the bushing bearing according to the invention, the elastic portion of the end segments arranged between the rigid inner ring and the rigid outer ring is made of an elastomer which is more temperature-stable than the other parts of the elastomeric bearing body arranged on the center main segment. In this way, thermally very robust bushing bearings can be realized, without limiting the damping comfort of the bearing and its long-term performance. This would not be possible if the entire bearing body were made of a highly temperature-stabile elastomer, because it has been observed that particularly temperature-stabile elastomers disadvantageously have inferior long-term performance when subjected to mechanical loads. When the bearings are exposed to high temperatures, their elastomeric components experience increased wear due to the thermal stress, which may cause premature failure in particular in the region of mechanically highly stressed expanding walls of the chambers. It has been observed that at high temperatures the elastomer has a tendency to become brittle and to finally crumble, causing leaks in the region of the expanding walls. However, with the segmented construction of the inner bearing part of the bushing bearing according to the invention and by using a more temperature-robust elastomer for the end segments, the end segments can withstand the stress at high temperatures in the region of the expanding walls, thereby improving the long-term performance under mechanical stress compared to the more temperature-robust elastomers. With respect to the more temperature-robust construction of the expanding walls, a silicone-rubber-mixture can be used for the elastomeric elements of the end segments. Particularly advantageously, an ethylene-propylene-diene mixture (EPDM) can be used for these elastomeric elements.

According to a particularly preferred embodiment, the channel support element of the bushing bearing according to the invention is made of plastic. Plastic can be used for the channel support because the channel support is pushed onto the outside of the bearing body between the bearing body and the outer sleeve. This avoids problems associated with the vulcanization of conventional channel support elements made of plastic, which are vulcanized into the bearing body while being freely held during the vulcanization process inside the mold in the region to be filled with elastomer for the bearing body. In addition, channel support elements made of plastic can be manufactured at much lower costs than the conventional so-called aluminum channel cages which are also vulcanized in the bearing body. In addition, the use of plastic advantageously reduces the weight. Moreover, the bearing can be much more easily tuned with the exterior channel support element made of plastic due to the intentional pretension of the elastomeric bearing body. A separate calibration process for producing the pretension in the elastomeric bearing body, where the diameter of the outer sleeve is reduced, can be eliminated, because the elastomer is already pretensioned, due to the compliance of the plastic, when the inner bearing body, which is surrounded by the channel support element and connected by vulcanization, is pressed into the outer sleeve. By moving the channel from the interior of the bearing body into a channel support element arranged between the bearing body and the outer sleeve, the increased available space offers more possibilities for the geometric design of the channel. Particularly advantageously, mass damping channels with a large channel length can be realized. For example, the channel according to a particular embodiment of the invention extends over the entire axial length of the channel support element. It terminates in the corresponding chamber at a respective end face of the channel support element in the region of the transition between the main segment and the respective end segments of the inner bearing part.

In an embodiment of the bushing bearing according to the invention relating to the structure of the bearing core, the bearing core is composed of a hollow-cylindrical inner sleeve made of metal and an outer bearing core pressed onto the inner sleeve and made of plastic. The metallic inner sleeve protrudes axially on both sides from the outer bearing core made of plastic. In this embodiment of the bushing bearing, the end segments of the inner bearing are pressed onto the protruding ends of the inner sleeve.

Because the radial stops, unlike with conventional bearings, are not implemented on the axial ends of the bearing with corresponding clips, but are instead disposed inside the bearing, namely in the chambers, significantly more space is available for their design. According to a preferred embodiment, the radial stops, which are formed from the elastomer of the bearing body, extend inside the chambers on the outside of the aforementioned outer bearing core made of plastic over the entire axial length of the outer bearing core. The bushing bearing formed in this way can advantageously absorb high cardanic loads and large cardanic angles, respectively.

With the segmented structure of the inner bearing part, the functions in the bearing of the invention are separated such that static loads are absorbed by the elastomer of the center main segment, whereas the hydraulic function is provided by the expanding walls of the separate end segments. Advantageously, the ribs of the center main segment can be designed to be rather wide because the channel is moved into the outer bearing region or into the channel support element arranged outside the bearing party, respectively, and therefore constructed to be very durable with respect to the absorbed static loads, while simultaneously the thickness of the material for the expanding walls and their curvature can be varied over a wide range because these are formed in the end segments. An improved dynamic characteristic of the bearing and an improved performance of C_{static} to C_{dynamic} can be attained with thinner expanding walls due to the improved compliance.

### BRIEF DESCRIPTION OF THE SEVERAL VIEWS OF THE DRAWING(S)

The invention will now be described in more detail with reference to an exemplary embodiment. The appended drawings show in:

FIG. 1 a possible embodiment of the bushing bearing according to the invention in a three-dimensional exploded view,

FIG. 2 the bearing of FIG. 1 in an assembled state, in an axial cross-section,

FIG. 3 the bearing according to FIG. 2 in a radial cross-section,

FIG. 4a a bearing in an embodiment according to FIG. 1 to FIG. 3 in a cross-sectional view with an axial section through the ribs, and

FIG. 4b an enlarged detail of the bearing according to FIG. 4a.

### DETAILED DESCRIPTION OF THE INVENTION

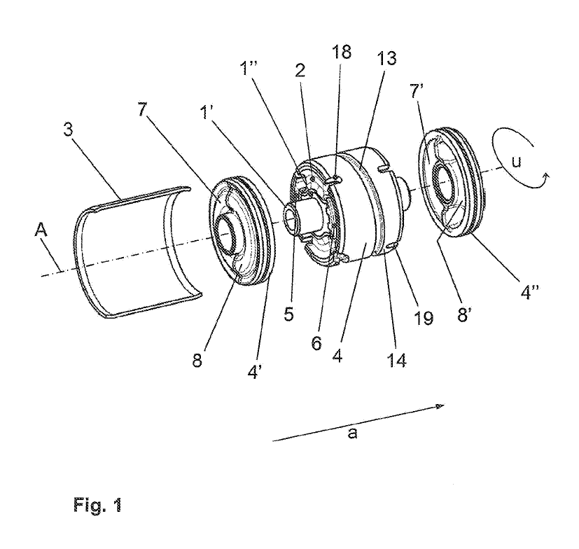

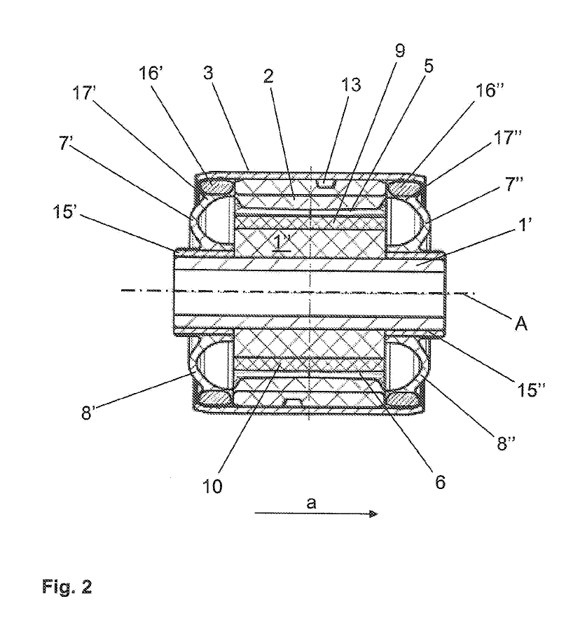

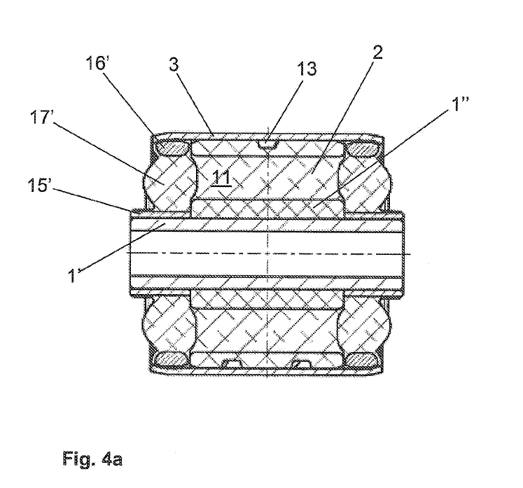

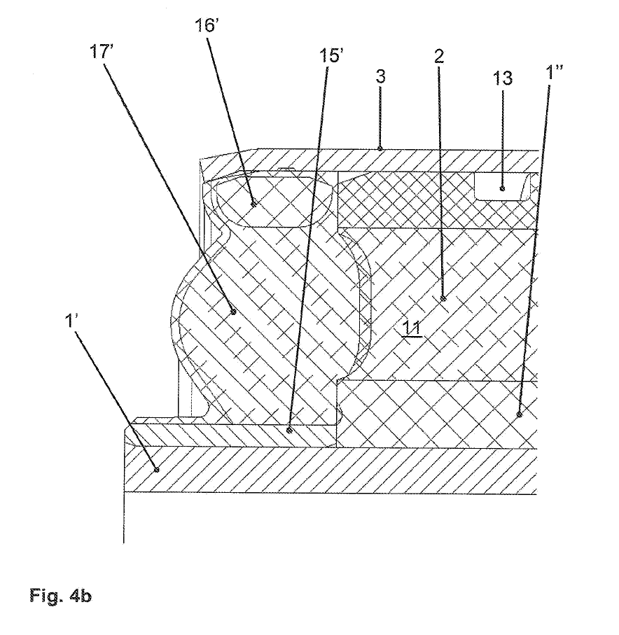

FIG. 1 shows a possible embodiment of the bushing bearing according to the invention in a three-dimensional view. The bearing is shown in the Figure in an exploded view. It is composed of an inner bearing part 4, 4′, 4″ and an outer sleeve 3 receiving the inner bearing part 4, 4′, 4″, wherein the outer sleeve 3 is shown in the diagram with a cut-out circumferential segment. The inner bearing part 4, 4′, 4″ is constructed in segments with respect to the longitudinal axis A of the bearing. It consists of the center main segment 4 with the bearing core 1′, 1″ and the elastomeric bearing body 2, which is connected with the bearing core 1′, 1″ through vulcanization and in which the chambers 5, 6 for the damping means are formed. The outside of the chambers is axially delimited by the two end segments 4′, 4″ with the expanding walls 7′, 7″, 8′, 8″ formed thereon. The end segments 4′, 4″ (see FIG. 2) consist of a rigid inner ring 15′, 15″, a rigid outer ring 16′, 16″ and an elastic or elastomeric element 17′, 17″ arranged between the inner ring 15′, 15″ and the outer ring 16′, 16″. As illustrated in the Figure, the elastic or elastomeric element 17′, 17″ surrounds the rigid outer ring 16′, 16″ of the end segments 4′, 4″, i.e., the rigid outer ring 16′, 16″ is completely surrounded by the material of the elastomeric element 17′, 17″ (see also FIG. 4b).

When the bearing is installed, the end segments 4′, 4″ are each pressed onto the axially outer ends of the bearing core 1′, 1″. In the illustrated example, the bearing core 1′, 1″ consist of two components, namely a hollow-cylindrical metallic inner sleeve 1′ and a plastic outer bearing core 1″ surrounding the inner sleeve 1′, which is pressed on to the inner sleeve 1′, with the inner sleeve 1′ extending through both end faces of the outer bearing core 1″. As shown in FIG. 1, the two end segments 4′, 4″ are each pressed with their inner ring 15′, 15″ onto the segments of the inner sleeve 1′ which project through the outer bearing core 1″. In this approach, the chambers 5, 6 of the bearing are sealed in the region of the ribs 11, 12, which separate the chambers 5, 6 in the circumferential direction, against the elastomeric bearing body 2 (see FIG. 4). The channel 13, which connects the chambers 5, 6 with each other and enables the flow of the fluidic damping means from one of the chambers 5, 6 into the respective other chamber 6, 5, is due to the seal of the bearing body 2 against the outer end segments 4′, 4″ formed in a rigid channel support element 14 made of plastic, which is pushed onto the bearing body 2 and rigidly connected with the bearing body 2 through vulcanization. In the illustrated embodiment, the channel 13 is configured as a long mass damping channel. As can be seen in the diagram of FIG. 1, a respective inlet and outlet 18, 19 for the damping means forming transition to the chambers 5, 6 is arranged at the ends of the channel 13.

FIG. 2 shows once more the bearing according to FIG. 1 in an assembled state in a cross-sectional view, with the section extending lengthwise in the axial direction a through the chambers 5, 6 of the bearing. All components of the bearing are clearly visible in this cross-sectional view. These are the center main segment 4 of the inner bearing part 4, 4′, 4″ with the bearing core 1′, 1″ constructed of a metallic inner sleeve 1′ and the pressed-on outer bearing core 1″ and the elastomeric bearing body 2, which surrounds the bearing core 1′, 1″ and is connected with the bearing core 1′, 1″ through vulcanization; additionally, the outer end segments 4′, 4″ which are pressed onto the two axial end faces of the bearing core 1′, 1″ and each include a rigid inner ring 15′, 15″, a rigid outer ring 16′, 16″, and an interposed elastomeric element 17′, 17″ for forming the expanding walls 7′, 7″, 8′, 8″ for the chambers 5, 6, and finally the outer sleeve 3 of the bushing bearing which receives the hereby formed inner bearing part 4, 4′, 4″. Also shown are the channel support element 14 arranged between the bearing body 2 and the outer sleeve 3, which includes the channel 13 formed therein as well as the radial stops 9, 10 arranged in the chambers 5, 6.

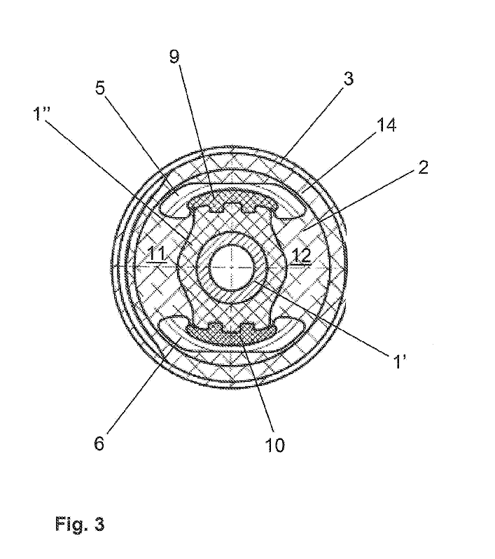

FIG. 3 shows once more the bearing in a cross-sectional view, with the section extending radially through the bearing. Particularly, the ribs 11, 12 separating the chambers 5, 6 in the circumferential direction u are visible in addition to the aforementioned elements of the bearing.

FIG. 4a shows once more the bearing of the invention in an embodiment according to FIG. 1 to FIG. 3. In this diagram, the bushing bearing is shown in an axial section, wherein the section extends, unlike in FIG. 2, through the ribs 11, 12. FIG. 4b shows on an enlarged scale a detail of the bearing of the invention according to FIG. 4a. The detail relates to the end portion of the bearing. This Figure illustrates the particular approach or arrangement of the axially outer end segments 4′, 4″ by depicting one half of an end segment 4′ which is shown, as mentioned above, in a longitudinal cross-section. The end segment 4′ consists of a rigid inner ring 15′ which is pressed onto the bearing core 1′, 1″ or its inner sleeve 1′, a rigid outer ring 16′ surrounding the inner ring 15′, and an interposed elastomeric element 17′. The position of the end segment 4′ is secured in the axial direction a in the radially inner region by the press fit between its inner ring 15′ and the bearing core 1′, 1″ and in the radially outer region by the outer sleeve 3 of the bearing, which has slightly beaded or narrowed axial ends. The end segment 4′ is pressed onto and affixed to the bearing core 1′, 1″ in such a way that the material of the elastomeric element 17′ overlaps with the elastomeric ribs 11, 12 of the bearing body. The chambers 5, 6 are here sealed against the bearing body 2 in the region of the ribs 11, 12, thereby safely preventing flow of damping means from one chamber 5, 6 into the other chamber along the ribs 11, 12. The flow-conducting connection of the chambers 5, 6 for the damping means is therefore provided by the channel 13 formed outside the bearing body 2 in the separate rigid channel support element 14. The elastomeric elements 17′, 17″ of the end segments 4′, 4″ are preferably made of a different material than the bearing body 2 and its ribs 11, 12 on the center main segment 4 of the bearing. The elastomeric elements 17′, 17″ of the outer end segments 4′, 4″ can then be formed from a thermally more robust elastomer than the main part of the bearing body 2, without adversely affecting the damping characteristic and without creating problems in continuous operation.

Without deviating from the principle of the invention, the bearing body 2 can also have a different geometry than the exemplary embodiment shown in the aforedescribed figures. For example, the ribs 11, 12 may be interrupted at the ends in the circumferential direction u of the bearing by a pocket extending into the bearing body 2 in the axial direction a. This produces an embodiment, also referred to as “X-Leg”, representing essentially a four-rib support.

### LIST OF REFERENCES SYMBOLS

1′, 1″ Bearing core
1′ inner sleeve
1″ outer bearing core
2 Bearing body
3 Outer sleeve
4 Main segment of the inner bearing part
4′, 4″ End segment
5, 6 Chamber
7′, 7″ Expanding wall
8′, 8″ Expanding wall
9, 10 Radial stop
11, 12 Rib
13 Channel
14 Channel support element
15′, 15″ Inner ring
16′, 16″ Outer ring
17′, 17″ Elastomeric element
18, 19 Inlet and outlet for damping means
a Axial direction
u Circumferential direction
A Longitudinal axis

1-8. (canceled)

9. A hydraulically damping bushing bearing comprising
an outer sleeve (3) and an inner bearing part (4, 4′, 4″) received by the outer sleeve (3) with a rigid, sleeve- or strand-shaped metallic bearing core (1′, 1″), an elastomeric bearing body (2) surrounding the bearing core (1′, 1″) and connected with the bearing core (1′, 1″) through vulcanization, and with at least two chambers (5, 6) for fluidic damping means, with the chambers (5, 6) each having at least one elastomeric expanding wall (7′, 7″, 8′, 8″) and a radial stop (9, 10), wherein the chambers (5, 6) are separated in the circumferential direction (u) of the bearing by ribs (11, 12) of the bearing body (2) and connected by at least one channel (13) configured as a mass damping channel or a flow restrictor channel for the damping means, wherein the inner bearing part (4, 4′, 4″) is segmented along the longitudinal axis (A) of the bearing and the expanding walls (7′, 7″, 8′, 8″) of the chambers (5, 6) are formed horizontally, meaning transverse to the longitudinal axis (A) of the bearing and as part of two end segments (4′, 4″) arranged at a respective axial end of a main segment (4) of the inner bearing part (4, 4′, 4″) and held by the bearing core (1′, 1″) and the outer sleeve (3) on the main segment (4), with the end segments (4′, 4″) comprising an inner ring (15′, 15″), an outer ring (16′, 16″) and an elastomeric element (17′, 17″) arranged between the inner ring (15′, 15″) and the outer ring (16′, 16″),
wherein the end segments (4′, 4″) are pressed with their inner ring (15′, 15″) onto the axial ends of the bearing core (1′, 1″) with a press fit so as to produce an overlap of the material between the elastomeric elements (17′, 17″) of the end segments (4′, 4″) and the ribs (11, 12) of the bearing body (2), by which the chambers (5, 6) are sealed in the region of the ribs (11, 12) against the bearing the body (2) and hence also with respect to each other, so that the channel (13) connecting the chambers (5, 6) is formed outside the sealed bearing body (2) in a rigid channel support element (14) arranged between the bearing body (2) and the outer sleeve (3) and connected with the bearing body (2) through vulcanization.

10. The hydraulically damping bushing bearing according to claim 9, wherein the elastomeric element (17′, 17″) of the end segments (4′, 4″) is made of an elastomer which is more temperature-stable than the elastomer of the center main segment (4).

11. The hydraulically damping bushing bearing according to claim 10, wherein the elastomeric element (17′, 17″) of the end segments (4′, 4″) is made of a silicone-rubber mixture.

12. The hydraulically damping bushing bearing according to claim 10, wherein the elastomeric element (17′, 17″) of the end segments (4′, 4″) is made of an ethylene-propylene-diene-monomer rubber mixture.

13. The hydraulically damping bushing bearing according to claim 9, wherein the channel support element (14) is made of plastic.

14. The hydraulically damping bushing bearing according to claim 9, wherein the channel (13) extends over the entire axial length of the channel support element (14) and the channel (13) terminates in one of the chambers at a respective end face of the channel support element (14) in the region of the transition between the main segment (4) and an end segment (4′, 4″) of the inner bearing part.

15. The hydraulically damping bushing bearing according to claim 9, wherein the bearing core (1′, 1″) comprises a hollow-cylindrical inner sleeve (1′) made of metal and a plastic outer bearing core (1″) pressed onto the inner sleeve (1′), wherein the inner sleeve (1′) protrudes axially from both sides of the outer bearing core (1″) and the end segments (4′, 4″) are pressed onto these ends of the metallic inner sleeve (1′) which project over the outer bearing core (1″).

16. The hydraulically damping bushing bearing according to claim 15, wherein the radial stops (9, 10) are formed of the elastomer of the bearing body (2) and extend inside the chambers (5, 6) over the entire axial length of the outer bearing core (1″).
